(19) United States
(12) Patent Application Publication
(10) Pub. No.: US 2002/0012803 A1
(43) Pub. Date: Jan. 31, 2002

(54) Heat-shrinkable laminate useful for packaging

(76) Inventor: Terrance D. Kending, Newark, DE (US)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/933,695

(22) Filed: Aug. 21, 2001

Related U.S. Application Data
(63) Continuation-in-part of application No. 09/494,354, filed on Jan. 31, 2000.
Application No. 09/494,354 is a continuation-in-part of application No. 09/105,558, filed on Jun. 26, 1998, now abandoned.
Application No. 09/105,558 is a division of application No. 08/854,830, filed on May 12, 1997, now Pat. No. 5,873,218.
Application No. 09/105,558 is a division of application No. 08/646,195, filed on May 7, 1996, now abandoned.
Application No. 08/646,195 is a continuation-in-part of application No. 08/414,568, filed on Mar. 31, 1995, now abandoned.
(60) Provisional application No. 60/049,940, filed on Jun. 24, 1996.

(51) Int. Cl. B32B 27/00; B65D 65/00

(52) U.S. Cl. 428/423.7; 53/442; 206/497

(57) ABSTRACT

A heat shrinkable film laminate contains (a) a heatable shrinkable film, (b) a solventless adhesive and (c) a film having a heat shrinkage of at least 5% less than the heat shrinkable film (a). Preferably the laminate also contains (d) a barrier layer adjacent (a).

### CROSS REFERENCE TO RELATED APPLICATION

This application is a continuation-in-part of application Ser. No. 09/494,354, filed Jan. 31, 2000 which is a continuation-in-part of prior application Ser. No. 09/105,558, filed Jun. 26, 1998, which was a division of patented prior application Ser. No. 08/854,830, filed May 12, 1997, both entitled Packaging System Capable of Venting Steam While Remaining Tamper Resistant and Methods Relating Thereto, which was a continuation-in-part of prior application Ser. No. 08/646,195, filed May 7, 1996, which was a continuation-in-part of prior application Ser. No. 08/414,568, filed Mar. 31, 1995, and entitled Closed Container and Packaging Process which was a continuation-in-part of provisional application Ser. No. 60/049,940, filed Jun. 24, 1996, and entitled Packaging System Capable of Venting Steam While Remaining Tamper Resistant and Methods Relating Thereto.

### BACKGROUND OF THE INVENTION

1. Field of the Invention

The present invention relates broadly to a particular type of polyester containing shrinkable film laminate. More specifically, this invention relates to a heat-shrinkable polyethylene terephthalate film coated with a solventless laminating adhesive for lamination to another film having no or different shrinkage, useful in packaging, e.g., as bags or lidding stock.

2. Discussion of the Related Art

The use of heat-shrinkable thermoplastic films is well-known to the packaging industry. For example, poultry products are typically sealed within bags made from such films, and heated, thus shrinking the bag until it fits tightly around the product. One such bag is monolayer polyester film. These bags provide strength and protection through tight adhesion to the product, though they have the drawback that they must be sealed with an adhesive since polyester is not heat-sealable except at exceptionally high temperatures. Bags sealed with adhesive are generally not as strong in the seal area as heat-sealed bags, and cannot be closed on the open end by existing heat-seal equipment.

Coextruded films, such as polyolefins, are useful in producing heat-shrinkable bags because they are heat-sealable and therefore can be produced on existing heat-seal equipment economically. They maintain good physical contact with a packaged product after heat shrinking, and thereby retain juices within packaged meats, but not as well as laminated shrink bags. However, coextruded film have less desirable mechanical properties, such as tensile strength and modulus, and therefore bags from these films are more apt to tear or otherwise become physically damaged during handling. As well, they generally do not possess high temperature heat resistance, which limits their application for cook-in uses.

U.S. Pat. No. 4,971,845 discloses an oriented heat-sealable, heat-shrinkable adhesive laminated film comprising, in one instance, a polyester film layer and a polyolefin film layer, wherein said film layers comprise similar shrink characteristics. The one example discussed combines layers each having “approximately the same shrinking characteristics”, i.e., a shrinkage of about 50%.

There exists a need for a thermoplastic film laminate which has high-strength, is heat-shrinkable, as well as high temperature heat resistant.

### SUMMARY OF THE INVENTION

This invention provides a heat shrinkable film laminate useful for packaging comprising in order:

(a) a heat shrinkable film comprising a polymer having at least 80% by weight polyethylene terephthalate polymer, wherein said film is biaxially oriented in the range of about 5% to about 55%, said film having an outer surface and an inner surface; and

(b) a solventless adhesive coating, and

(c) a film having a heat shrinkage of at least 5% less than (a).

In a preferred laminate, a barrier layer such as a polyvinylidene polymer layer is present adjacent (a).

### DETAILED DESCRIPTION OF THE PREFERRED EMBODIMENT(S)

The present invention is directed to a particular type of polyethylene terephthalate (“PET”) shrink film, and methods related thereto, that offers advantages in packaging for both non-cook and cook-in applications. The invention is based on the platform of (a) a first layer of a film of polyethylene terephthalate polymer, either homopolymer or copolymer, that is heat-shrinkable, typically thin-gauge and having low shrinkage in combination with (b) a second layer of a solventless lamination adhesive and (c) a third layer of a film having no shrinkage or less shrinkage than the heat shrinkable polyethylene terephthalate film. Furthermore, it is preferable in many applications for the three layer laminate to have an additional layer. The fourth layer acts to impart an oxygen and moisture barrier to the laminate which is critical in many food packaging applications. This layer is adjacent the heat shrinkable film containing PET. Although the barrier layer can be on either size of the heat shrinkable film, preferably it is intermediate the heat shrinkable film and the solventless adhesive coating. A preferrred example of a barrier layer is made from polyvinylidine chloride (PVDC).

Appearance of the layers is an important criteria in food packaging. The appearance is desired when packaging cuts of fresh meat or other products packaged in modified atmospheric conditions to extend product shelf life. Additional benefits over existing films are:

1) The heat shrinkable polyester film having very controlled machine direction/transverse direction (MD/TD) shrinkage eliminates deformation of a supporting tray.

Existing prior art films can shrink thus pulling the side walls of the container inward and deforming the container making the package appearance undesirable.

2) Using this specialty heat shrinkable polyester film on the outside of the structure is considered to provide much greater heat resistance over existing shrink lidding films in use. These prior art films are generally olefin based and have an approximate 30° fahrenheit processing window. The improved invention can expand the processing window in excess of 100° Fahrenheit.

3) Existing films are not as dimensionally stable and create more waste. For example: If the sealing equipment is stopped for any reason existing films sitting static under the seal heads will shrink prematurely. That section of film cannot be used causing another 6-10 feet of waste having to be wound off before starting the process again. The film structure in the new invention is considered more heat stable and eliminates this problem.

4) Existing films have to be shipped and kept in refrigerated conditions to eliminate premature film shrinkage If exposed to much more than ambient temperatures the film can be made unusable on the sealing equipment due to premature shrinkage. The film structure in the new invention does not require this extreme level of shipment and storage.

5) Because existing films do not have sufficient heat resistance, they have a tendency to stick and create polymer build up on the equipment heat seal heads and heated die cut knives thus causing down time and loss of production output. The new invention eliminates this problem.

6) Existing films do not cut cleanly in the die cut process. Generally the die cut knives are heated. The desire is after cutting the film it will shrink back to the container's outer flange next to the perimeter heat seal. Existing films tend not to cut cleanly due to poor heat resistance and leave fine strands of polymer hanging from the containers outside edge. The heat shrinkable polyester in the new invention eliminates the problem due to superior heat resistance because the film does not melt in the presence of a hot die cut knife process and cuts cleanly. 6) Existing film are generally coextrusions containing nylon and ethylene vinyl alcohol as the barrier. Both materials are hydroscopic and their oxygen and gas barrier will degrade in the presence of a moist product such as a cut of fresh meat. On the other hand PVDC is not influenced by moisture and its barrier remains stable when packaging moist product.

### Heat-Shrinkable Base Film

The heat-shrinkable, polyethylene terephthalate (PET) shrink film, i.e. “base film” of the present invention comprises at least about 80 wt % PET, more preferably at least about 90 wt % PET. The PET can be a homopolymer or copolymer of PET. A PET homopolymer is intended to mean a polymer substantially derived from the polymerization of ethylene glycol with terephthalic acid, or alternatively, derived from the ester forming equivalents thereof (e.g., any reactants which can be polymerized to ultimately provide a polymer of polyethylene terephthalate). A copolymer of PET is intended to mean any polymer comprising (or derived from) at least about 50 mole percent ethylene terephthalate, and the remainder of the polymer being derived from monomers other than terephthalic acid and ethylene glycol (or their ester forming equivalents).

The PET base films of the present invention are further defined as:

1. being biaxially oriented in the range of about 5%-55% shrink factor, more preferably in the range of about 5% or 10%-30% shrink factor; and

2. for lidding applications, having a thickness in the range of 12-75 micrometers (more preferably 12-20 micrometers).

Suitable polyethylene terephthalate shrink films are available from E. I. du Pont de Nemours and Company, Wilmington, Del. under the trademarks Mylar® and from DuPont Teijin Films as Melinex®.

Relative to conventional shrink film, the shrink film of the present invention are advantageous in packaging applications for a number of reasons. The PET shrink film is tough relative to many conventional shrink films, and the film's relatively small amount of orientation (“low shrinkage”) has been found to better accommodate protrusions, by not shrinking to such an extent as to risk puncturing the film or crushing protruding contents, and by not shrinking to such an extent as to agglomerate an ugly mass of shrunken film around the protrusion or to deform the container after lidding.

When first shrunk to a package, the base film of the present invention forms a tight hermetic seal due to the presence of the sealant layer. Seals can be made to an outer wall, outer lip edge, top of the lip and bridges separating compartments to prevent spillage from one to the other. Another advantage is this type of construction can be used in a variety of Modified Atmospheric Packaging (MAP) formats.

The relatively low shrink force films of the present invention also provide excellent appearance and are generally more economical to use than conventional (higher gauge, higher shrinking) shrink films, especially for lidding applications, because they minimize the amount of material needed for coverage of the product and container being used.

The heat shrinkable PET base film has other additional advantages. It can be surface printed stand alone or trap printed when laminating. It can be laminated, carrying varying degrees of shrink % 5-45, to a secondary web, dependent upon the thickness, stiffness and shrinkage of said second web. The percent shrink of the shrinkable PET in turn governs shrinkage of the final structure. The multi-layer laminated heat sealable versions can be used as heat shrinkable lidstocks, bag materials and thermoformable webstock. All versions can be used to package materials other than foodstuffs

### Solventless Laminating Adhesive

Solventless laminating adhesives are well known in the art and illustratively include waterborne acrylic emulsions, polyurethane dispersions and one and two part 100% solids polyurethane systems. Waterborne systems require dryers after adhesive application at elevated temperatures to eliminate the water berfore combining with another substrate. On the other hand 100% solids polyurethane systems rely on a chemical reaction for curing and little or no heat is required.

A preferred class of adhesives are elastomeric such as polyurethanes. However, the adhesive need not be elastomeric.

The laminating adhesive can be applied either to the heat shrinkable film of (a) previously described or to a film having heat shrinkage of at least 5% less than (a). Once or both of these films can be surface treated such as by corona. However such pretreatment is not essential in obtaining the results of the present invention. The laminating adhesive can be applied by well known coating techiques such as metering a low viscosity adhesive onto a multiple application roll system configuration that applies the adhesive to a first web or substrate. The first web is then mated to a second web or substate by use of a heated nip roll. The advantage is the elimination of solvent, little heat is required and a relatively small amount of adhesive is needed to provide the finished laminate performance needs.

### Other Film

The final film necessary in the present invention has a heat shrinkage of at least 5% less than the heat shrinkage film, previously described. Preferably the heat shrinkage is at least 10%. It is understood that the above heat shrinkage numerical values are inclusive of films which have no heat shrinkage. In many applications it is preferred that the final film has no shrinkage under the conditions in which contraction of the heat shrinkage film occurs. Examples of polymeric films useful for the final film are nylyon, polypropylene, polyethylene, ionomer, acid copolymer, ethylene vinyl acetate, polyethylene terephthalate, polystyrene, ethylene vinyl alcohol, polyvinylidene chloride, multi-layer coexetrusions and combinations thereof.

### Barrier Coating

In food packaging applications particularly where resistance to oxygen and moisture is needed, it is preferred in the present invention to employ a barrier layer.

The barrier layer is adjacent the heat shrinkable PET bse film. “Adjacent” in the present context means the barrier layer can be on either side of the PET base film. Accordingly, the barrier may be on the base film side opposite (i.e., away from) the required solventless adhesive. However, preferably the barrier is intermediate the PET base film and the solventless adhesive.

A preferred barrier layer is a vinylidene polymer and particularly polyvinylidine chloride polymer including copolymers. These barrier layers are well known and are valuable to the food packaging industry because they provide superior resistance to fat, oil, water and steam as well as resistance to permeation of gas and odors.

Application of barrier coatings are well known and include gravure or roller coating. However, when removal of any solvent is necessary from the barrier coating, care must be taken to prevent premature shrinking of the base PET film due application of heat.

### Use in Packaging Generally

In use, the film laminate can be used in a myriad of application. For lidding, the film is draped over a tray to be lidded and die cut to size larger than the the face of the container to compensate for film shrinkage when exposed to heat. The film is then held in place by a mechanical device, platen seal head or the like. Heat and pressure is then applied to the outside surface of the polyester heat shrinkable laminated film structure, thereby causing the polyester to shrink and control the laminated non or differential shrink sealant ply, simultaneously activating the heat seal layer thus producing a wrinkle free and hermetically sealed package. The film can be shrunk additionally along its center portion to further tighten the film and eliminate wrinkles or the like.

For other applications, the film may be presealed to form open bags, which may then be filled with contents in an in-line packaging machine. The bags are then sealed, and heated to shrink the bag around the contents. Such bags can be made to be ovenable dependent upon sealant selection, and may become self-venting once the internal temperature and pressure reach the softening point of the sealant.

For thermoforming applications the film can be used to form pockets and then filled with contents in an in line packaging machine. The pockets can then be heat sealed closed using the same film structure as the capping web in horizontal form, fill and seal applications.

For lidding the films of the present invention are well suited because the film, once shrunk, is substantially non-elastomeric. Also, the film can be hermetically sealed to the container. This is important for modified atmosphere packaging (MAP) and applications requiring hermetic sealing to the tray and across bridges between compartments. This prevents spillage during handling and distribution.

The heat-shrinkable, heat-sealable laminate film is recommended when lidding disposable containers, particularly trays made of crystalline PET (CPET), amorphous PET (APET), paper, aluminum, polypropylene (PP), polethylene (PE), polyvinyl chloride (PVC), polvinylidene chloride (PVDC) or polystyrene (PS). The desired substrate determines what type material sealant web is to be laminated to the heat shrinkable PET base. For packaging fresh refrigerated product a PE type sealant web and sealant surface is preferred.

The films of the present invention can also provide a relatively small amount of shrinkage, relative to conventional shrink films, while still providing the sealing advantages of a shrink film. This makes the film simple and easy to use.

To futher illustrate the present invention, the following examples are provided.

### EXAMPLE 1

### Shrinkage Characteristics of Film Components Before and After Lamination

Table below represents shrinkage values of film components stand alone and then again after being combined into a lamination. The measurements were made by testing three replicates of each sample tested. The test method generally involved placing a 5 inch by 5 inch sample in a heated bath of boiling water. The length of the sample was measured in both the machine direction (MD) and transverse direction (TD) and the percent shrinkage calculated as indicated.

| Film Sample | Initial | Final | MD | % Change |
|---|---|---|---|---|
| 1A) 0.5 Mil Heat Shrinkable PET | 100 | 84.6 | MD | −15.4 |
| | 100 | 75.3 | TD | −24.7 |
| 1B) 1.25 Mil FE | 100 | 100 | MD | 0 |
| | 100 | 100 | TD | 0 |
| 1C) 0.5 Mil Heat Shrinkable PET/adh/ | 100 | 85.6 | MD | −14.4 |
| 1.25 Mil PE | 100 | 80.6 | TD | −19.4 |
| 1D) 1.5 Mil 5 Layer Coex | 100 | 96.6 | MD | −1.4 |
| | 100 | 101 | TD | 0.99 |
| 1E) 0.5 Mil Heat Shrinkable PET/adh/ | 100 | 88.3 | MD | −11.7 |
| 1.5 Mil 5 Layer Coex | | | | |
| | 100 | 89 | TD | −11 |

Notes: Examples 1C and 1E are within the scope of invention.
Examples 1A and 1D provided material used in Example 1C or 1E
“Adh” is an adhesive Mor-Free 403A which is diphenylene iusocyanate from Morton International
“Coex” is Linear Low Density Polyethylene (LLDPE)/adhesive/ethylene vinyl alcohol (EVOH)/adhesive/LLDPE
MD means machine direction
TD means traverse direction

### EXAMPLE 2

### Lidding Film for Containers

A rectilinear molded container for foodstuffs having approximate dimensions of 6¾″ by 8¾″ by 1½″ deep is lidded using a 0.5 mil heat shrinkable polyethylene terephthalate film adhesive which is Mor Free 403A (diphenylene dusocyanate) laminated to a 1.25 mil non shrinkable, heat sealable layer of polyethelyene film. The total thickness of the structure is approximately 1.75 mils. The combined MD/TD shrinkage of the laminate as shown in Example 1 is approximately −17%.

The film is die cut to a size greater than the outside perimeter dimension of the flange or lip of the container. The film size ratio compensates for film shrinkage once heat is introduced by the sealing equipment. During die cutting, the film is held in physical contact across the open face of the container by a mechancial device such as a platen or the like. The film is heat sealed to the container using temperature, pressure and dwell time. In this example the equipment uses a heated platen set at 300° fahrenheit, seal pressure of 30 psi and dwell time of one second. As the heated platen is in contact with the film it will shrink and seal simultaneously to the container creating a hermetic seal and tamper evident package. Upon removal of the platen the film heat sealed to the container is very neat and tight across the open area. The tightness is caused by the heat shrinkable polyester terephthalate film.

### EXAMPLE 3

### Laminating to Other Films

The heat-shrinkable PET base film can also be adhesive laminated to other materials to enhance performance of the overall structure, depending on the packaging need. The shrinkable base to be used can be plain uncoated or with a polyvinylidene chloride barrier layer to give the final package increased shelf life.

For example, both uncoated heat shrinkable base film and a one-side coated polyvinylidene heat shrinkable base film was laminated to a linear low-density polyethene film. The polyvinylidene chloride coated version can provide enhanced barrier properties for providing extended shelf life. In this example the heat shrinkable base has an approximate shrinkage of 20% in both the MD/TD directions. The linear low polyethelyne in this case was a non-shrinkable version but with an anti-fogging feature. This is critical in a lidding application where the product must be seen clearly through the film at refrigerated conditions. A two part polyester urethane adhesive was applied to the heat shrinkable PET via a gravure cylinder to serve as the laminating adhesive. The laminating adhesive is applied across the web, from solution.

The shrinkage of the PET base film and the additional films to be laminated need not be similar; in fact shrinkage differences of about 5% and much greater pose no problem. The amount of shrinkage will be dictated by the heat-shrinkable PET base, but just as important by the thickness and stiffness of the secondary web. An example would be when adhesive laminating to a thicker or stiffer substrate, in order to gain the shrinkage desired from the laminate, a higher percentage of shrinkage may be required of the PET base sheet. It is preferred to choose a solventless laminating adhesive in which no or little heat is introduced that could prematurely shrink the film.

It is recommended that both surfaces be corona treated prior to application of the solventless adhesive in order to promote better bonding between the film surfaces in contact with the applied adhesive as was done in this example.

The invention herein provides for a heat shrinkable, heat sealable lidding system which can be used to package fresh meat, poultry and seafood in modified atmospheric packaging applications. The barrier, anti-fogging features combined with a sealant that can seal through contamination can provide greater economic benefit due to reducing the materials and labor in fresh product packaging operations. These types of construction are also useful in fabrication of heat shrinkable, heat sealable bags and thermoformable structures for packaging any variety of products.

What is claimed is:

1. A heat shrinkable film laminate useful for packaging comprising in order:
(a) a heat shrinkable film comprising a polymer having at least 80% by weight polyethylene terephthalate polymer, wherein said film is biaxially oriented in the range of about 5% to about 55%, said film having an outer surface and an inner surface; and
(b) a solventless adhesive coating; and
(c) a film having a heat shrinkage of at least 5% less than (a).

2. The laminate of claim 1 wherein the film of (c) having a heat shrinkage of at least 10% less than (a).

3. The laminate of claim 1 wherein the film of (c) having substantially no heat shrinkage.

4. The laminate of claim 1 wherein the film of (c) is selected from the group consisting of nylon, polypropylene, polyethylene, ionomer, acid copolymer, ethylene vinyl acetate, polyethylene terephthalate, polystyrene, ethylene vinyl alcohol, polyvinylidene chloride, and coextruded combinations thereof.

5. The laminate of claim 1 wherein the solventless adhesive coating (b) is selected from the group consisting of waterborne acrylic emulsion and polyurethane.

6. The laminate of claim 1 wherein the solventless adhesive coating (b) is elastomeric.

7. The laminate of claim 6 wherein the solventless adhesive coating (b) is polyurethane.

8. A heat shrinkable film laminate useful for packaging comprising in order:
(a) a heat shrinkable film comprising a polymer having at least 80% by weight polyethylene terephthalate polymer, wherein said film is biaxially oriented in the range of about 5% to about 55%, said film having an outer surface and an inner surface; and
(b) a solventless adhesive coating; and
(c) a film having a heat shrinkage of at least 5% less than (a), and
(d) further comprising a barrier layer adjacent the heat shrinkable film (a).

9. The laminate of claim 8 wherein the film of (c) having a heat shrinkage of at least 10% less than (a).

10. The laminate of claim 8 wherein the film of (c) having substantially no heat shrinkage.

11. The laminate of claim 8 wherein the film of (c) is selected from the group consisting of nylon, polypropylene, polyethylene, ionomer, acid copolymer, ethylene vinyl acetate, polyethylene terephthalate, polystyrene, ethylene vinyl alcohol, polyvinylidene chloride, and coextruded combinations thereof.

12. The laminate of claim 8 wherein the solventless adhesive coating (b) is selected from the group consisting of waterborne acrylic emulsion and polyurethane.

13. The laminate of claim 8 wherein the solventless adhesive coating (b) is elastomeric.

14. The laminate of claim 13 wherein the solventless adhesive coating (b) is polyurethane.

15. A package adopted to contain a food comprising a tray in combination with a heat shrinkable film laminate comprising in order:
(a) a heat shrinkable film comprising a polymer having at least 80% by weight polyethylene terephthalate polymer, wherein said film is biaxially oriented in the range of about 5% to about 55%, said film having an outer surface and an inner surface; and
(b) a solventless adhesive coating; and
(c) a film having a heat shrinkage of at least 5% less than (a), and
(d) further comprising a barrier layer adjacent the heat shrinkable film (a).
